(19) United States
(12) Patent Application Publication
(10) Pub. No.: US 2012/0238443 A1
(43) Pub. Date: Sep. 20, 2012

(54) MANUFACTURE OF BASE METAL NANOPARTICLES USING A SEED PARTICLE METHOD

(76) Inventors: Dan V. Goia, Potsdam, NY (US); Marco Lopez, Frankfurt am Main (DE); Igor V. Sevonkaev, Potsdam, NY (US)

(21) Appl. No.: 13/049,165

(22) Filed: Mar. 16, 2011

(51) Int. Cl. H01B 1/02; C22C 19/07; C22C 9/00; B01J 23/00; B22F 9/16; C22C 19/03; B82Y 99/00; B82Y 40/00

(52) U.S. Cl. 502/300; 75/370; 75/351; 420/435; 420/456; 420/497; 252/512; 977/773; 977/810; 977/900

(57) ABSTRACT

The present invention is directed to a process for manufacture of base metal nano-particles using precious metal seed particles.

The process comprises the steps of mixing at least one base metal precursor and at least one precious metal precursor in one or more polyol solvents, reacting the mixture at a temperature in the range of 110 to 150° C. to form precious metal seed particles (STEP A) and reacting the mixture at a temperature in the range of 180 to 220° C. to form the final metal particles (STEP B). Base metal particles of Co, Ni and Cu containing 100 to 10000 ppm of precious metals Ru, Pd, Pt or Ir are obtained.

The resulting metal nano-particles with medium diameters of 20 to 200 nm are useful for electronic and catalytic applications and can be used as core materials for the manufacture core/shell type catalysts.

### FIELD OF INVENTION

The present invention is directed to a method for manufacture of metal nanoparticles, in particular to the manufacture of nano-sized base metal particles. The manufacturing process of the present invention is based on the so-called “seed particle method” or “seed-mediated method”. By this method, size-controlled base metal particles with a medium particle diameter in the range of 20 to 200 nm can be produced using small precious metal seed particles (“nuclei”) to initiate the particle formation.

In a further aspect, the invention is directed to the nano-sized particles obtained by that method. These particles may be used in a variety of applications such as, e.g., in electronic applications, in gas-phase catalysis or in catalytic converters for automobiles.

### BACKGROUND OF INVENTION

An important use of the base metal particles of the present invention is for core materials in core/shell-type catalyst particles such as, for example, Pt coated Ni particles (Ni@Pt) or Pt-coated Co particles (Co@Pt). Such core/shell-type catalyst particles gain increased importance in the literature and find use as catalysts for fuel cells or electrode materials for batteries. Especially the particles with a Pt-based shell, such as Ni@Pt or Au@Pt reveal a high specific activity. As an advantage, they possess a low precious metal content due to the core/shell structure. The catalyst particles are characterized by a high specific mass activity (“SMA”) and an improved performance in oxygen reduction reactions (“ORR”) at the cathode of PEMFCs (Polymer electrolyte membrane fuel cells) or DMFCs (Direct methanol fuel cells). Thus, core/shell-type catalysts are designed for use as electrocatalysts in fuel cells, predominantly in mobile applications (ref to WO2008/0225750A1 and WO2008/025751A1).

The use of seed-mediated methods and/or seed particle methods for the preparation of nanoparticles is well known in the literature.
Zhu-Chuan Xu et al., Nanotechnology 18, 2007, 115608 described the preparation of Au particles.
I. Srnova-Sloufova et al., Langmuir, 2004, 20, 3407-3415 reported the preparation of bimetallic Ag@Au particles using Ag seed particles.
L. Lu, H. Zhang et al. prepared Pd particles with 20-100 nm size by employing gold seeds (ref to L. Lu, H. Zhang et al., J. Mater. Chem., 2002, 12, 156-158.

US2010/0072434 discloses a method for preparing metal nanoparticles, preferably gold particles, using a metal seed. This method includes preparing an solution of a polymeric surfactant in an alcohol solvent, heating the solution, forming a metal seed by adding a first metal chosen from platinum, palladium or iridium in the heated solution and adding a second metal into the solution including the metal seed. However, the resulting metal nanoparticles are coated by the polymeric surfactant. Thus, as their surface is blocked with organic material, these particles are generally not suitable as core particles for the manufacture of core/shell-type catalyst materials. Further, as seed formation and metal reduction is taking place at the same time, the process of US2010/0072434 is difficult to control.

In summary, the seed mediated methods known to date are mostly directed to the manufacture of precious metal particles. Frequently, capping agents or organic surfactants agents are employed in the preparation for stabilizing the resulting particles, which are generally coated with organic materials. Therefore it is difficult to use such particles in the manufacture of core/shell-type catalyst materials.

### SUMMARY OF THE INVENTION

It is an objective of the present invention to provide a process for the manufacture of nano-sized base metal particles of nickel (Ni), cobalt (Co) and copper (Cu) having a medium diameter in the range of 20 to 200 nm. Primarily, these metal particles should be suitable for use as core materials in the preparation of core/shell-type catalyst materials. Therefore, the particle surface should contain only traces of any organic dispersing, capping or stabilizing agents. Furthermore, these particles should be suitable for use in fired and/or non-fired electronic applications such as internal electrode pastes for MLC, conductive inks, die attach adhesives and thick-film pastes.

Furthermore, the process should be based on a simple synthesis route; it should be environmentally safe and should be easily scaleable for industrial production with high yields.

The invention is directed to a process for preparing nano-sized base metal particles using a seed particle method, comprising the steps of
i) mixing precursor compounds of at least one base metal and at least one precious metal in one or more polyol solvents,
ii) reacting the mixture at a temperature in the range of 110 to 150° C. for a period of 10 to 120 minutes to form precious metal seed particles (STEP A),
iii) reacting the mixture at a temperature in the range of 180 to 220° C. for a period of 2 to 12 hours to form the metal particles (STEP B),
iv) and optionally cooling down the reaction mixture to room temperature and isolating the metal particles.

### BRIEF DESCRIPTION OF DRAWINGS

FIG. 1 shows a schematic drawing of the general temperature profile of the process of the present invention.

FIG. 2 shows a SEM picture.

FIG. 3 shows a SEM picture of the resulting Cu particles.

### DETAILED DESCRIPTION

Generally, the process is conducted as a one-pot synthesis in organic polyol solvents. It is characterized by as 2-step reduction process, in which small seed metal particles are generated in the first step (STEP A) in the presence of the base metal precursor compound and the base metal is subsequently reduced around the seed particles in the second step (STEP B).

The seed particles comprise a precious metal selected from the group consisting of ruthenium (Ru), palladium (Pd), platinum (Pt) and iridium (Ir) and mixtures thereof. Preferably the seed particles are platinum (Pt) or iridium (Ir).

The base metal is selected from the group consisting of cobalt (Co), nickel (Ni) and copper (Cu) and mixtures and alloys thereof. Preferably the base metal is nickel (Ni) or copper (Cu).

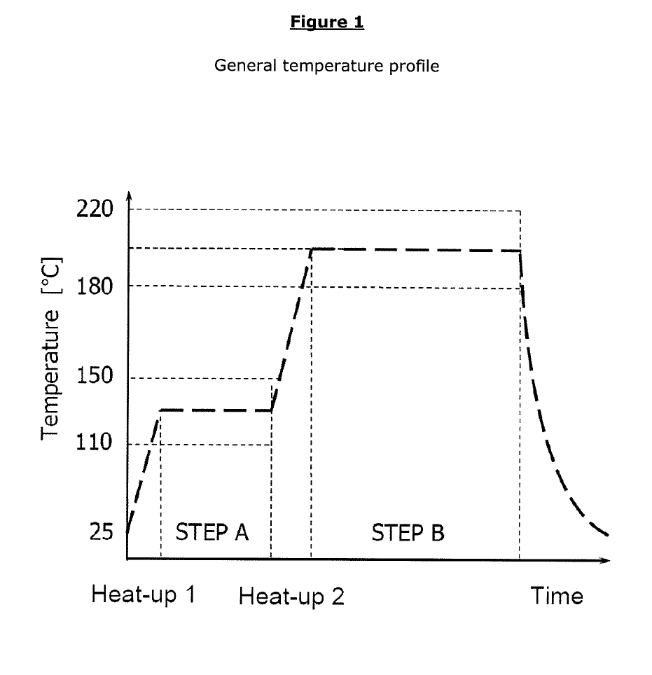

In one embodiment of the invention, the process comprises two reduction steps (STEPS A and B), which are characterized by the different reaction temperatures employed. These two reaction steps, namely seed formation (STEP A) and particle growth of the base metal (STEP B), are controlled by the temperature course of the reaction. A schematic drawing of the general temperature profile of the process of the present invention is shown in FIG. 1.

As can be seen in this schematic drawing, STEP A (seed particle formation) is conducted at temperatures in the range of 110 to 150° C. for a period of 10 to 120 minutes. Furthermore, STEP B (base metal reduction and particle growth) is conducted at temperatures in the range of 180 to 220° C. for a period of 2 to 12 hours. The heating rate to reach the temperature plateau of STEP B (“heat-up 2”) should be in the range of 3 to 10° C./min.

It should be noted that the heating rate to reach STEP A of the reaction (“heat-up 1”) is not critical. Thus, an additional heating step in the start-up phase of the reaction (for example heating to 50-80° C. for dissolving the precursor compounds in the reaction mixture) may be added in the “heat-up 1” phase.

Further additional steps may be added to this general reaction profile as long as the temperature-dependent, two-step reaction scheme is maintained. For example, a cool-down phase may be added at the end of the reaction. The reaction mixture may be quenched or slowly (naturally) cooled to room temperature and the particles may be separated by filtration. Such variations and additions are within the embodiments of the invention.

It was found by the inventors that the seed particle method applied in this process is essential and provides very fine metal particles in the range of 20 to 200 nm. If the formation of seed particles is omitted in the reduction process, coarser particles in the range of 500 nm size are obtained (ref to Comparative Example).

It was further found by the inventors, that the different metals employed (precious metal seeds and base metals) are reduced at different temperatures in the polyol solvent system. More precisely, the precious metals used for seed formation (i.e. Ru, Pd, Pt and Ir) are reduced at temperatures in the range of 110 to 150° C., whereas the base metals (i.e. Co, Ni and Cu) are reduced at temperatures starting at 180° C. in the polyol system. These findings allow a precise control of the seed formation process independently from the subsequent particle formation. As a result, the process provides nano-sized particles with a narrow size distribution and a uniform, regular shape.

In a typical reaction procedure, at least one suitable precursor compound of the base metal is dissolved in one or more polyol solvents and the at least one precious metal precursor compound for seed formation is added at temperatures in the range of 25 to 80° C. The total concentrations of the metals (base metal and seed metal) in the polyol solvent system may be varied in a wide range; concentrations in the range of 1 to 20 g metal/L, preferably in the range of 1 to 10 g metal/L are feasible.

Thereafter, the reaction mixture is heated to a temperature in the range of 110 to 150° C. At this temperature, the reaction mixture is held for a period of 10 to 120 minutes, in which the precious metal seed particles are formed by reduction in the polyol solvent. It is important to note that these seed particles are formed in the presence of the base metal precursor. This is contrary to the method disclosed in US2010/0072434, which teaches one single heating process.

After completion of STEP A, the reaction mixture is rapidly heated to a temperature in the range of 180 to 220° C. and held there for a period of 2 to 12 hours. During this time, the reduction of the base metal takes place and the final metal particles are formed (STEP B).

It was found that the seed particles formed in STEP A of the reaction (i.e. at a temperature range of 110 to 150° C.) are acting not only as nucleating agents; they additionally catalyze the reduction of the base metal at the higher temperatures applied. Therefore the heating rate for increasing the reaction temperature from STEP A to STEP B should be rapid (i.e. at heating rates of 3 to 10° C./min). By this measure, particles with a narrow size distribution and a medium size in the range of 20 to 200 nm, preferably in the range of 20 to 150 nm are obtained.

The reaction temperature of STEP B is maintained for about 2 to 12 hours, preferably for 3 to 10 hours to complete the reduction of the base metal. After completion, the reaction mixture may be cooled down to room temperature in a further step; the cool-down rate is not critical and may be in the range of 1 to 10° C./min. Quenching of the reaction mixture may also be possible.

The resulting metal particles are separated from the reaction mixture by conventional separation steps (filtration, centrifugation, decantation etc). Further treatment steps, known to the person skilled in the art, may be added (e.g. washing, drying, screening etc.).

Suitable polyol solvents for use in the present process are ethylene glycol (EG), 1,2-propanediol (propylene glycol), diethylene glycol (DEG), triethylene glycol and/or mixtures thereof. Preferably, the boiling point of the polyol system employed should be above 180° C. As long as this condition is verified, small quantities of lower boiling solvents may be added.

Furthermore, solid polyol compounds, such as, e.g., sorbitol may be employed as additives.

Preferably, the process is carried out under a protective gas atmosphere, for example under argon (Ar) or nitrogen (N₂). A reducing atmosphere (such as forming gas) may also be used. This measure avoids oxidation of the base metal particles and prevents rapid deterioration of the polyol solvents.

The resulting metal particles contain the base metals cobalt, nickel and copper (or mixtures or alloys thereof) and small amounts of ruthenium, palladium, platinum or iridium (or mixtures or combinations thereof) as seed material. In the context of the present invention, these metal particles are named “base metal” particles.

Generally, the concentration of Ru, Pd, Pt or Ir in these base metal particles is in the range of 100 to 10000 ppm (=0.01 to 1.0 wt.-% based on the base metal). Preferably the concentration of seed metal in the base metal particles is in the range of 200 to 5000 ppm (=0.02 to 0.5 wt.-% based on the base metal. It was found that a higher concentration of precious metal seed (>10000 ppm) does not decrease the size of the base metal further. For example, at a larger Pt excess, only a small part of the Pt is involved in the seed formation, while the majority is forming distinct Pt clusters on the surface of the base metal particle. This finding underlines the importance of process control, in particular the amount of precious metal seed formed.

Generally the size of the precious metal seed (“nuclei”) should be in the range of 1 to 10 nm, preferably in the range of 1 to 5 nm. Assuming that, in the case of a nickel particle prepared with a Pt seed method, the Pt seed particles are ˜3 nm, the final size of the Ni particles is controlled by the amount of Pt precursor added. For example, in order to obtain 5 g of 30 nm sized Ni particles, 11.9 mg of Pt is required. This can be reflected by the following calculation. If d>>D (30 nm>>3 nm), then the amount of Pt to be added is

$$M = m * \frac{P}{p} * \frac{{D}^{2}}{{d}^{2} - {D}^{2}} = 4.94 * \frac{21.45}{8.9} * \frac{{3}^{2}}{{30}^{3}} = 0.0119 g$$

This amount is ca. 0.24 wt.-% Pt based on the Ni content. In this equation, parameters D, M, P are the diameter (nm), mass (g), and density (g/cm³) of platinum seed particles and d, m, p are the diameter, mass, and density of nickel particles.

The process of the present invention provides very fine nano-sized metal particles. Generally, the medium diameter of the base metal particles is in the range of 20 to 200 nm, preferably in the range of 20 to 150 nm and particularly preferred in the range of 20 to 100 nm. Advantageously, the particles reveal a uniform shape, a narrow size distribution and, in most cases, high crystallinity. Furthermore, the particles contain very low levels of polymer residues or organic contaminants on their surface. Typically the amount of organic residues of the nano-sized particles is in the range of <0.5 wt.-% (as detected by TGA).

In the present process, the base metal is selected from the group consisting of nickel (Ni), cobalt (Co), copper (Cu) and alloys thereof. Preferably the base metal is cobalt or nickel. More preferred, the base metal is nickel (Ni).

Suitable precursor compounds of the base metals should be soluble in the polyol solvent system. Examples are the nitrates, sulfates, carbonates, hydrogen-carbonates and acetates of Co, Ni and Cu. Examples are Cu(II)-carbonate, Ni(II)-carbonate, Co(II)-sulfate, Cu(II)-acetate Cu(II)-hydrogen-carbonate or Co(II)-carbonate. Other precursor compounds, preferably chloride-free precursors may also be used. Further additives for control of basic or acidic environments and/or for buffering action may be added to the base metal precursor compounds (e.g. Na₂CO₃, K₂CO₃, NH₄ compounds etc). Suitable precursor compounds for the precious metal seed particles are the chlorides (incl. chloro complexes), acetates, nitrates and hydroxo-complexes of Ru, Pd, Pt and Ir. Specific examples are Ru(III)-acetate, Pd-nitrate, hexachloro-Ir(IV)-acid (H₂IrCl₆), Ir(III)-acetate or Bis-(ethanol-ammonium)-hexahydroxoplatinate(IV)-solution [HO—C₂H₄—NH₃]₂Pt(OH)₆ (also called “EA-platinum”). Other precious metal precursor compounds, preferably chloride-free precursor compounds, may also be used.

In summary, by the process of the present invention, uniform, nano-sized Co, Ni and Cu particles containing small amounts of the precious metals ruthenium, palladium, platinum or iridium are provided.

Thus, in a further aspect, the present invention is directed to cobalt, nickel and copper particles with a medium particle size in the range of 20 to 200 nm, containing at least one precious metal selected from the group of Ru, Pd, Pt or Ir in a concentration between 100 to 10000 ppm, preferably in a concentration between 200 to 5000 ppm (based on the base metal). These base metal particles may be used in a variety of applications, for example as core materials of core/shell type catalysts.

The invention is now explained in more detail by the following examples, which are considered illustrative, but not limiting to the scope of the invention and the resulting claims.

### General Experimental Remarks

Particle analysis: The resulting particles are inspected by Transmission and Scanning electron microscopes (TEM JEM-2010 and FESEM JEOL-7400). Crystal structure of the particles is determined by electro diffraction (JEM-2010) and by X-ray diffraction (XRD Bruker-AXS D8 Focus).

Elemental Analysis:

EA is performed by inductive coupled plasma analysis (ICP) using solutions obtained by chemical digestion of the materials. The differences between the calculated values and the amounts determined by ICP may result from the lack of appropriate digestion/dissolution methods.

Reaction Conditions:

Reactions are performed in clean glassware under argon or nitrogen protective atmosphere. High purity polyol solvents are employed.

### Example 1

Preparation of Ni Particles with Pt Seeds

In a glass reactor equipped with a reflux condenser and an appropriate heating bath, 11.0 g of basic nickel carbonate-tetrahydrate (NiCO₃×4H₂O; technical grade, 45 wt.-% Ni content; Shepherd Chemical Co., USA; corresponding to 4.94 g Ni) is dissolved in 200 ml 1,2-propylene glycol at room temperature (25° C.). After a uniform solution has been formed, 0.140 g of Bis-(ethanolammonium)-hexahydroxoplatinate solution [HO—C₂H₄—NH₃]₂Pt(OH)₆; “EA-platinum”; 8.46 wt.-% Pt; Umicore AG & Co KG, Hanau, Germany, corresponding to 0.0119 g Pt) is added at once. The concentration of Pt is 0.24 wt.-%, based on the weight of Ni metal employed.

After the addition of the Pt precursor compound, the reaction mixture is heated to 115° C. and held there for 60 minutes. During this period the Pt seed particles are formed exclusively, the nickel carbonate does not react. After the generation of the Pt seed particles, the reaction temperature is rapidly raised to 180° C. (heating rate of 5° C./min) to achieve Ni particle formation. At 180° C., the temperature is maintained for 3 hours. Thereafter the solution is naturally cooled to room temperature and a suspension of Ni particles containing Pt seeds is obtained.

### Particle Characteristics:

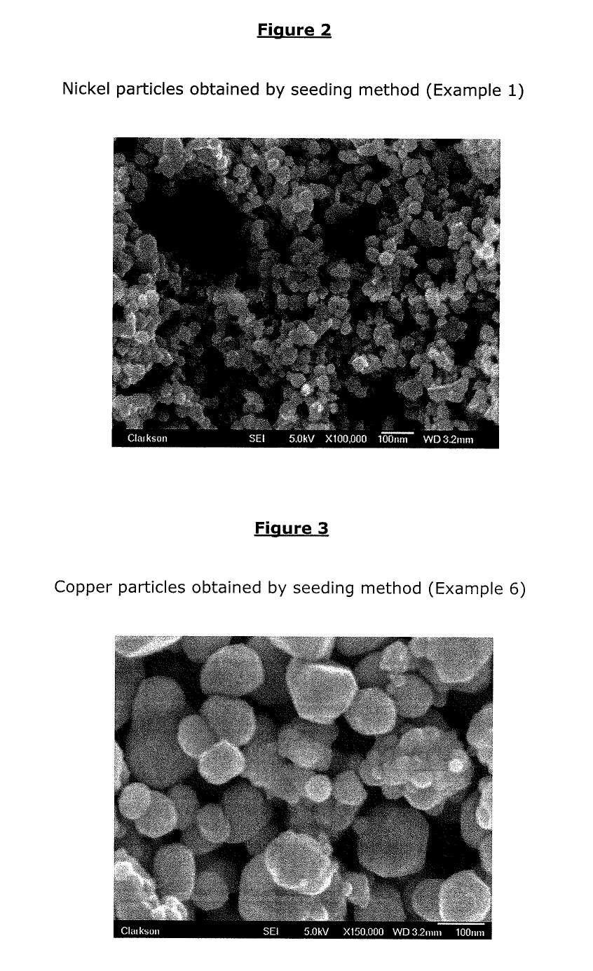

Medium diameter of Ni (by SEM): ˜30 nm
Content of Pt: 0.24 wt.-% (calculated)
Content of Pt: 0.20 wt.-% (analyzed by ICP)
A SEM picture is shown in FIG. 2.

### Example 2

Preparation of Ni Particles with Pt Seeds

11.0 g of basic nickel carbonate-tetrahydrate (NiCO₃×4H₂O; technical grade, 45 wt.-% Ni content; Shepherd Chemical Co., USA; corresponding to 4.94 g Ni) is dissolved in a mixture of 100 ml 1,2-propylene glycol and 100 ml diethylene glycol (DEG) in a glass reactor equipped with a reflux condenser and an appropriate heating bath. Next the solution is heated to 80° C. to dissolve the Ni carbonate. After this temperature is reached, 0.0175 g of [HO—C₂H₄—NH₃]₂Pt(OH)₆; “EA-platinum”; 8.46 wt.-% Pt; Umicore AG & Co KG, Hanau, Germany; corresponding to 0.00148 g Pt) is added at once. The resulting concentration of platinum in Ni is 0.03 wt.-% based on the Ni metal employed.

After the addition of the Pt compound, the solution is heated to 115° C. and held at this temperature for 60 minutes. During this period the Pt seeds are formed exclusively, the nickel carbonate does not react. After the generation of the seeds, the temperature is rapidly raised to 180° C. with a heating rate of 4° C./min to achieve the formation of uniform Ni particles. At 180° C. the temperature is maintained for three (3) hours. After three hours the reaction mixture is naturally cooled to room temperature.

Due to the lower concentration of Pt in the reaction mixture, less Pt-seed particles are formed, hence the Ni finds less seeds. Therefore, at the same given amount of nickel precursor compound, the particles grow larger.

### Particle Characteristics:

Medium diameter of Ni (by SEM): ˜60 nm
Content of Pt: 0.03 wt.-% (calculated)

### Example 3

Preparation of Ni Particles with Ir Seeds

In a glass reactor equipped with a reflux condenser and an appropriate heating bath, 11.0 g of basic nickel carbonate (ref to Example 1, corresponding to 4.95 g Ni) is dissolved in a mixture of 100 ml of 1,2-propylene glycol and 100 ml of diethylene glycol. Next the solution is mixed at 300-400 rpm and quickly heated to 80° C. After the reaction mixture has reached this temperature, 0.05 g of hexachloro-iridium(IV)acid solution (H₂IrCl₆, 20.44 wt.-% Ir; Umicore AG & Co KG, Hanau; corresponding to 0.01 g Ir) is added at once. The corresponding concentration of iridium in nickel is 0.2 wt.-%. After the addition of the Ir compound, the reaction temperature is heated to 145° C. and the mixture is held there for 15 minutes to form the iridium seeds.

Then the temperature is rapidly raised to 180° C. with a heating rate of 4° C./min and held at that temperature for 4.5 hours. Thereafter the reaction mixture is naturally cooled to room temperature and a suspension of Ni particles containing Ir seeds is obtained.

### Particle Characteristics:

Medium diameter of Ni (by SEM): ˜40 nm
Content of Ir: 0.2 wt.-% (calculated)
0.15 wt.-% (analyzed by ICP)

### Example 4

Preparation of Co Particles with Pt Seeds

A round glass reactor (size 0.5 L) is charged with 100 ml of 1, 2-propanediol and 100 ml of diethylene glycol and 4.02 g of cobalt carbonate (CoCO₃, 45.5 wt.-% Co, Shepherd Comp., corresponding to 1.83 g Co). The mixture is stirred at 300-400 rpm and heated to 80° C. under argon gas. Then, 0.024 g Pt in the form of Bis-(ethanolammonium)-hexahydroxoplatinate solution [HO—C₂H₄—NH₃]₂Pt(OH)₆; “EA-platinum”; 8.46 wt.-% Pt; Umicore AG & Co KG, Hanau, Germany, corresponding to 0.002 g Pt) is added. The corresponding concentration of platinum in cobalt is 0.11 wt.-%.

The mixture is heated to 115° C. and maintained at this temperature for 15 minutes in order to form the Pt seeds. Then the temperature is quickly raised to 180° C. (heating rate 4° C./min) and the mixture is held at this temperature for 10 hours. After 10 hours, the reduction of cobalt is complete and resulted in the formation of Co particles with a medium particle size of 100 nm. Thereafter the reaction mixture is naturally cooled to room temperature and a suspension of Co particles containing Pt seeds is obtained.

### Particle Characteristics:

Medium diameter of Co (by SEM): ˜100 nm
Content of Pt: 0.11 wt.-% (calculated)

### Example 5

Preparation of Co Particles with Ir Seeds

A round glass reactor (size 0.5 L) is charged with 200 ml of diethylene glycol (DEG) and 4.02 g of cobalt carbonate (CoCO₃, 45.5 wt.-% Co, Shepherd Comp.; corresponding to 1.83 g Co). The mixture is stirred at 300-400 rpm and heated to 80° C. under argon gas. Then, 0.25 g Ir(III)-acetate solution (4.15 wt.-% Ir; Umicore AG & Co KG, Hanau, Germany; corresponding 0.01 g Ir) is added. The resulting concentration of Ir in cobalt is 0.56 wt.-% (based on the final Co weight).

The mixture is heated to 130° C. and maintained at this temperature for 15 minutes in order to form the Ir seeds. Then the temperature is quickly raised to 200° C. (heating rate 7° C./min) and the mixture is held at this temperature for 10 hours. After 12 hours, the reduction of cobalt is complete and results in the formation of Co particles with a medium particle size of 100 nm. Then the reaction mixture is naturally cooled to room temperature and a suspension of Co particles with Ir seeds is obtained.

### Particle Characteristics:

Medium diameter of Co (by SEM): ˜100 nm
Content of Ir: 0.56 wt.-% (calculated)

### Example 6

Preparation of Cu Particles with Ir Seeds

A round glass reactor (size 0.5 L) is charged with 3.76 g of copper (II)-carbonate, (CuCO₃, min. 55 wt.-% Cu, Shepherd Co., corresponding to 2.07 g Cu), 0.5 g of Na₂CO₃, 100 ml of 1,2-propanediol and 100 ml of diethylene glycol and heated under mixing to 80° C. After that 0.028 g of hexachloro-iridium(IV)acid solution (H₂IrCl₆, 20.44 wt.-% Ir; Umicore AG & Co KG, Hanau, corresponding to 0.0057 g Ir) is added at once. The resulting concentration of Ir in copper is 0.15 wt.-%.

The temperature in the reactor is raised to 145° C. and held there for 15 minutes to form the Ir seeds. Then the mixture is rapidly heated to 180° C. (heat-up rate 4° C./min). The reactor is kept at 180° C. for 10 hours and then cooled. The nanosized Cu particles obtained are separated, washed repeatedly and analyzed in SEM and XRD.

### Particle Characteristics:

Medium diameter of Cu (by SEM): ˜100 nm
Content of Ir: 0.15 wt.-% (calculated)
A SEM picture of the resulting Cu particles is enclosed in FIG. 3.

### Comparative Example

20 g of nickel carbonate powder (NiCO₃, Shepherd Co.) are dissolved in 200 ml of diethylene glycol (DEG) in a spherical glass reactor with slow purge of argon gas. Temperature is raised to 225° C. and the dispersion is mixed for 18 h at 350-400 rpm. Note that there is no other seed material added; only NiCO₃ is employed. Without seeding, the reduction of nickel carbonate is temperature dependent and a slow process. After 18 h the reduction is completed and the resulting particles are separated from the reaction mixture. The Ni particles obtained have a medium particle size of 470 nm (by SEM).

1. A process for preparing nano-sized base metal particles using a seed particle method, comprising the steps of
i) mixing precursor compounds of at least one base metal and at least one precious metal in one or more polyol solvents,
ii) reacting the mixture at a temperature in the range of 110 to 150° C. for a period of 10 to 120 minutes to form precious metal seed particles (STEP A)
iii) reacting the mixture at a temperature in the range of 180 to 220° C. for a period of 2 to 12 hours to form the metal particles (STEP B),
iv) optionally cooling down the reaction mixture to room temperature and isolating the metal particles.

2. The process according to claim 1, wherein the base metal is selected from the group consisting of cobalt (Co), nickel (Ni) and copper (Cu) and mixtures and alloys thereof.

3. The process according to claim 1, wherein the precious metal is selected from the group consisting of ruthenium (Ru), palladium (Pd), platinum (Pt) and iridium (Ir) and mixtures thereof.

4. The process according to claim 1, wherein the precious metal is added in a concentration in the range of 100 to 10000 ppm (based on the total amount of base metal).

5. The process according to claim 1, wherein the precursor compound of the base metal is selected from the group consisting of metal carbonates, metal hydrogen-carbonates, metal sulfates, metal nitrates, metal acetates and mixtures and combinations thereof.

6. The process according to claim 1, wherein the precursor compound of the precious metal is selected from the group consisting of metal acetates, metal chlorides, metal acid chlorides, metal nitrates, metal hexa-hydroxo complexes or metal hexa-chloro complexes and mixtures and combinations thereof.

7. The process according to claim 1, wherein the polyol solvent is selected from the group consisting of ethylene glycol, 1,2-propylene glycol, diethylene glycol, triethylene glycol and mixtures thereof.

8. The process according to claim 1, wherein the heat-up rate between the reaction temperature of STEP A and the reaction temperature of STEP B is in the range of 3 to 10° C./min.

9. The process according to claim 1, wherein the nano-sized metal particles have a medium particle size in the range of 20 to 200 nm.

10. Cobalt particles with a medium particle size in the range of 20 to 200 nm containing at least one precious metal selected from the group consisting of Ru, Pd, Pt or Ir in a concentration between 100 to 10000 ppm.

11. Nickel particles with a medium particle size in the range of 20 to 200 nm containing at least one precious metal selected from the group consisting of Ru, Pd, Pt or Ir in a concentration between 100 to 10000 ppm.

12. Copper particles with a medium particle size in the range of 20 to 200 nm containing at least one precious metal selected from the group consisting of Ru, Pd, Pt or Ir in a concentration between 100 to 10000 ppm.

13. Use of the particles obtained the process according to claim 1 for manufacture of core-shell type catalyst particles.

14. Use of the particles obtained the process according to claim 1 for electronic applications.
